(19) United States
(12) Patent Application Publication
(10) Pub. No.: US 2024/0144205 A1
(43) Pub. Date: May 2, 2024

(54) SYSTEM FOR TRANSMITTING AND RECEIVING DATA AND METHOD OF DOING THE SAME

(71) Applicant: Cognitive Research Labs, Inc., Tokyo (JP)

(72) Inventor: Hideto TOMABECHI, Tokyo (JP)

(21) Appl. No.: 18/241,924

(22) Filed: Sep. 4, 2023

(30) Foreign Application Priority Data
Nov. 2, 2022 (JP) 2022-176461

(51) Int. Cl. G06Q 20/06; G06Q 20/10; H04L 47/27

(52) U.S. Cl. CPC G06Q 20/0652; G06Q 20/10; H04L 47/27; G06Q 2220/00

(57) ABSTRACT

A system includes a first server for transmitting data, a second server for receiving the data from the first server; a network for connecting the first server and the second server to each other; and a clock for measuring passage of time, the data having such a structure that at least amount among value and amount thereof is reduced with passage of time, the clock transmitting a time-passage signal to the second server every time a predetermined period of time has passed from a point of time at which the data was transmitted to the second server from the first server through the network, the second server, on receipt of the time-passage signal, transmitting a reduced amount of the data to the first server.

### JOINT INVENTORS UNDER 37 C.F.R. 1.77(b)(6)

Applicant designates the following article (publication) as a grace period publication in order to expedite examination of the application in accordance with 37 CFR 1.77(b)(6) and MPEP 608.01(a): “Credit Creation and Universal Basic Income through the use of cryptocurrency having a half-valued period” (Lecturer: Hideto TOMABECHI (Fellow of Carnegie Melon University, Visiting Professor of Study House in Waseda University)) at 5TH Annual Conference of Japan Association of Basic Income, published in Japan Association of Basic Income Official Site (https://jabi.jp/), released on Oct. 7, 2022. A copy of the article with an English translation of a substantive part thereof is provided in a concurrently filed with Information Disclosure Statement, pursuant to the guidance of 78 Fed. Reg. 11076 (Feb. 14, 2013).

### BACKGROUND OF THE INVENTION

### Field of the Invention

The invention relates to a system for transmitting and receiving data (in particular, data comprising cryptocurrency), a method of doing the same, a server to be used in the system, and a non-transitory storage medium storing a program therein for using a server in the system.

### DESCRIPTION OF THE RELATED ART

Various cryptocurrencies (virtual currencies or digital currencies) such as bitcoin (BTC) and ethereum (ETH) are now available. These cryptocurrencies are used for payment similarly to legal currencies such as Japanese yen (JPY) and US dollar (USD), that is, used as substitution of legal currencies. Since cryptocurrencies are not under control of a particular nation, they have advantages different from those of legal currencies. However, current cryptocurrencies merely have economical value no more than that of legal currencies.

Though cryptocurrencies have a potential capable of contributing to a society in dependence on their characters and specification, current major cryptocurrencies such as BTC and ETH have such an aspect.

### SUMMARY OF THE INVENTION

In view of the above-mentioned present situation of cryptocurrencies, it is an exemplary object of the present invention to provide a system including a particular data structure such as particular cryptocurrency, capable of providing serviceability to a society or contributing to a society.

It is further an exemplary object of the present invention to provide a method, a server and a storage medium capable of doing the same.

In a first exemplary aspect of the present invention, there is provided a system for transmitting and receiving data, including a first server for transmitting data, at least one second server for receiving the data from the first server, a network for connecting the first server and the second server to each other, and a clock for measuring passage of time, the data having such a structure that at least amount among value and amount thereof is reduced with passage of time, the clock transmitting a time-passage signal to the second server every time a predetermined period of time has passed from a point of time at which the data was transmitted to the second server from the first server through the network, the time-passage signal indicating that the predetermined period of time has passed, the second server, on receipt of the time-passage signal, transmitting a reduced amount of the data to the first server.

It is preferable that the transmission of the data to the second server from the first server is carried out only when the second server satisfies a predetermined requirement.

For instance, the predetermined requirement is that an owner of the second server provides formless informational value to a society.

For another instance, the predetermined requirement is that an owner of the second server acquires knowledge from others, in which case, the first server may be designed to transmit the data to the second server in an amount in accordance with an amount of knowledge the owner of the second server acquired.

It is preferable that the data comprises cryptocurrency.

For instance, the passage of time with which the at least amount of the data is reduced is a half-life, an amount of the data being reduced to a half when the half-life has passed.

It is preferable that the second server comprises a cellular phone.

It is preferable that the clock is included in the second server.

For instance, the first server is a server of a central bank in a certain nation, and the second server is a server of people of the certain nation.

It is preferable that the cryptocurrency is prohibited to exchange with other cryptocurrencies and legal currencies.

In a second exemplary aspect of the present invention, there is provided a method of transmitting and receiving data between first and second servers through a network, the data having such a structure that at least amount among value and amount thereof is reduced with passage of time, the method including transmitting data to the second server from the first server through the network, successively measuring every passage of a predetermined period of time starting from a point of time at which the data was transmitted to the second server from the first server through the network, and the second server transmitting a reduced amount of the data to the first server every time the predetermined period of time has passed.

It is preferable that the transmitting data to the second server from the first server is carried out only when the second server satisfies a predetermined requirement.

For instance, the predetermined requirement is that an owner of the second server provides formless informational value to a society.

For another instance, the predetermined requirement is that an owner of the second server acquires knowledge from others, in which case, the first server transmits the data to the second server in an amount in accordance with an amount of knowledge the owner of the second server acquired.

It is preferable that the data comprises cryptocurrency.

It is preferable that the passage of time with which the at least amount of the data is reduced is a half-life, an amount of the data being reduced to a half when the half-life has passed.

For instance, the second server comprises a cellular phone.

It is preferable that the successively measuring every passage of a predetermined period of time is carried out in the second server.

For instance, the first server is a server of a central bank in a certain nation, and the second server is a server of people of the certain nation.

It is preferable that the cryptocurrency is prohibited to exchange with other cryptocurrencies and legal currencies.

In a third exemplary aspect of the present invention, there is provided a server for receiving data from other server through a network, the data having such a structure that at least amount among value and amount thereof is reduced with passage of time, the server including a clock for measuring passage of time to detect whether a predetermined period of time has passed from a point of time at which the server received the data from the other server, the server transmitting a reduced amount of the data to the other server when the passage of the predetermined period time was detected by the clock.

For instance, the data comprises cryptocurrency.

For instance, the passage of time with which the at least amount of the data is reduced is a half-life, an amount of the data being reduced to a half when the half-life has passed.

It is preferable that the server comprises a cellular phone.

For instance, the other server is a server of a central bank in a certain nation, and the server is a server of people of the certain nation.

In a fourth exemplary aspect of the present invention, there is provided a non-transitory storage medium readable by a computer and storing a program therein for transmitting data having been received from a first server through a network, back to the first server, the data having such a structure that at least amount among value and amount thereof is reduced with passage of time, the storage medium being included in a second server having a clock, wherein the program causes the second server to carry out making the clock to work to successively measure every passage of a predetermined period of time starting from a point of time at which the data was received at the second server from the first server, and transmitting a reduced amount of the data to the first server every time the passage of the predetermined period of time was detected by the clock.

It is preferable that the data comprises cryptocurrency.

For instance, the passage of time with which the at least amount of the data is reduced is a half-life, an amount of the data being reduced to a half when the half-life has passed.

It is preferable that the second server comprises a cellular phone.

For instance, the program prohibits the cryptocurrency to exchange with other cryptocurrencies and legal currencies.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1 is a block diagram of a system for transmitting/receiving data, in accordance with the first embodiment of the present invention.

FIG. 2 is a block diagram of an example of a cellular phone defining a second server in the system in accordance with the first embodiment of the present invention.

FIG. 3 is a flow-chart showing the operation of the system in accordance with the first embodiment of the present invention.

FIG. 4 is a block diagram of a system for transmitting/receiving data, in accordance with the second embodiment of the present invention.

FIG. 5 is a block diagram of a system for transmitting/receiving data, in accordance with the third embodiment of the present invention.

FIG. 6 is a block diagram of a system for transmitting/receiving data, in accordance with the fourth embodiment of the present invention.

### DESCRIPTION OF THE EXEMPLARY EMBODIMENTS

Exemplary embodiments in accordance with the present invention will be explained hereinbelow with reference to drawings.

### First Exemplary Embodiment

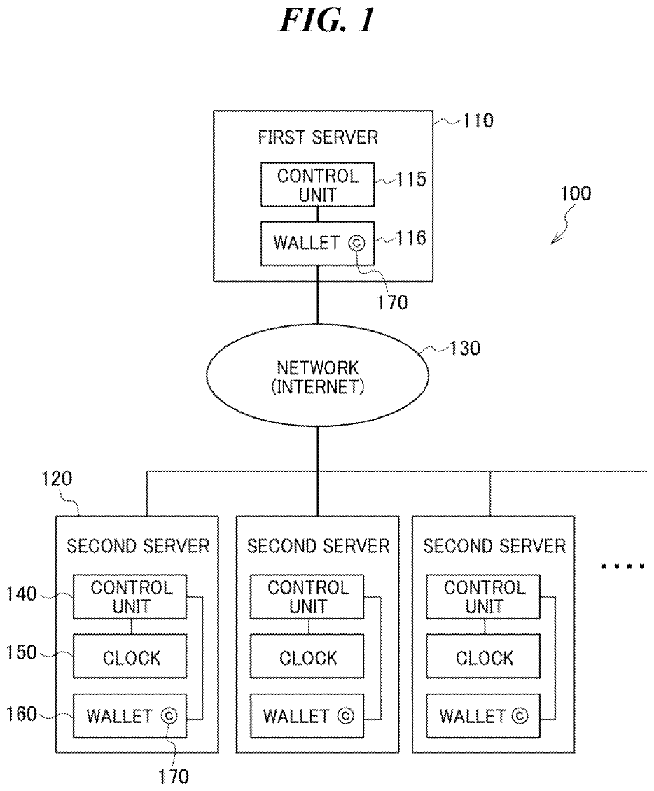

FIG. 1 is a block diagram of a system 100 for transmitting and receiving data, in accordance with the first exemplary embodiment of the present invention.

As illustrated in FIG. 1, the system 100 includes a first server 110 for transmitting data, a plurality of second servers 120 each receiving the data from the first server 110, and a network 130 connecting the first server 110 and the second serer 120 to each other.

The first server 110 includes a control unit 115 for controlling operation of the first server 110, and a wallet 116 as an application for storing later-mentioned cryptocurrency 170 therein.

Each of the second servers 120 includes a control unit 140 for controlling operation of the second server 120, a clock 50 for measuring passage of time and transmitting a signal indicative of the measurement result to the control unit 140, and a wallet 160 as an application for storing later-mentioned cryptocurrency 170 therein.

The network 130 is comprised of Internet, for instance.

Each of the second servers 120 may be designed to be comprised of a cellular phone.

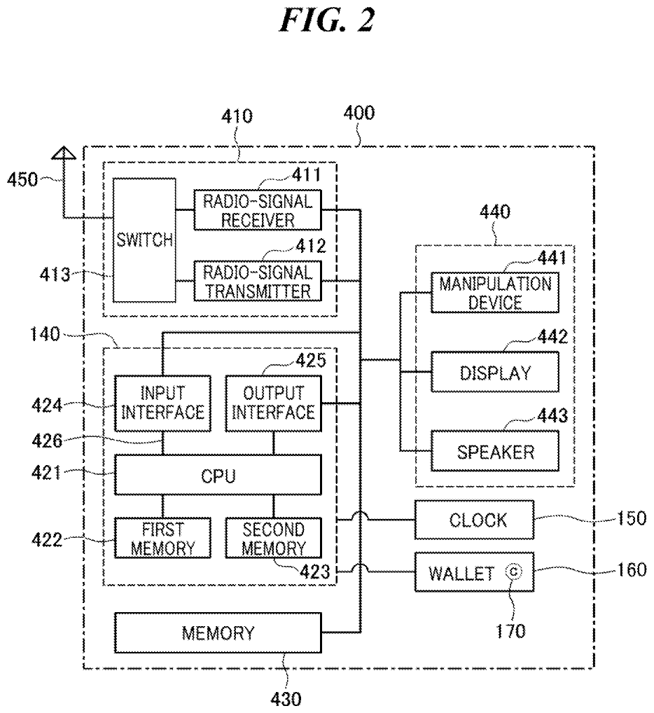

FIG. 2 is a block diagram illustrating an exemplary structure of a cellular phone 400 defining the second server 120.

A cellular phone 400 is designed to include, for instance, a communication unit 410, the above-mentioned control unit 140, a memory 430, an input-output (IO) unit 440, an antenna 450, a buttery (not illustrated) providing electric power to those units, a clock 150, and the above-mentioned wallet 160.

The communication unit 410 is connected to the antenna 450, and transmits data to and receives data from other cellular phones in radio-signal communication.

The communication unit 410 includes a radio-signal receiver 411, a radio-signal transmitter 412, and switch 413.

The radio-signal receiver 411 demodulates data received from other cellular phones, and then, transmits the demodulated data to the control unit 140. The radio-signal transmitter 412 modulates data output from the control unit 140, and then, transmits the modulated data to other cellular phones through the antenna 450. The switch 413 receives an instruction signal output from the control unit 140, and exchanges a transmission mode to a receipt mode and vice versa in accordance with the received instruction signal.

As illustrated in FIG. 2, the control unit 140 is comprised of a central processing unit (CPU) 421, a first memory 422 comprised of a read only memory (ROM), a second memory 423 comprised of a random access memory (RAM), an input interface 424 through which commands and/or data having been input into the control unit 140 are transmitted to the central processing unit 421, an output interface 425 through which a result of steps having been executed by the central processing unit 421 is output, and buses 426 through which the central processing unit 421 is electrically connected with the first memory 422, the second memory 423, the input interface 424, and the output interface 425.

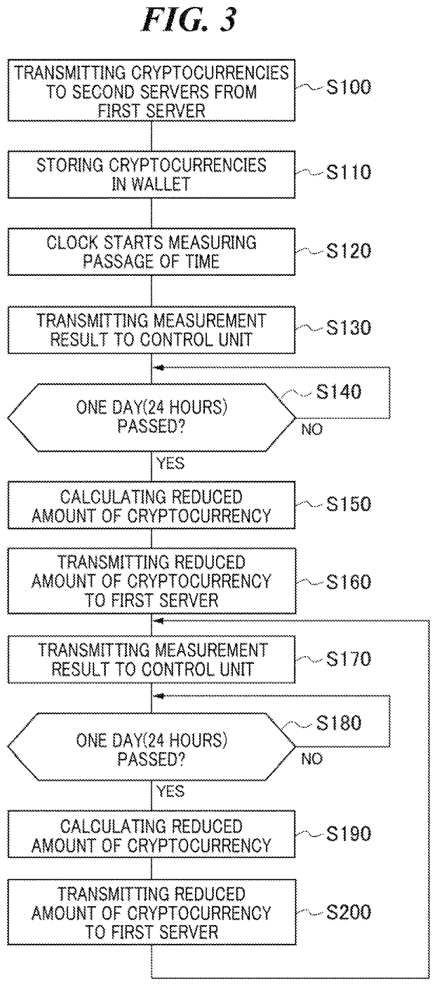

The first memory 422 stores therein both a program for causing the central processing unit 421 to execute the steps which will be explained with reference to FIG. 3, and unrewritable data.

Such a program may be presented through a non-transitory storage medium readable by a computer.

In the specification, the term “storage medium” means any medium which can store or record data and programs therein. The term “storage medium” includes, for instance, a disk-shaped recorder such as CD-ROM (Compact Disk-ROM) or PD, a magnetic tape, MO (Magneto Optical Disk), DVD-ROM (Digital Video Disk-Read Only Memory), DVD-RAM (Digital Video Disk-Random Access Memory), a floppy disk, a memory chip such as RAM (Random Access Memory) or ROM (Read Only Memory), EPROM (Erasable Programmable Read Only Memory), EEPROM (Electrically Erasable Programmable Read Only Memory), smart media (Registered Trade Mark), a flush memory, a rewritable card-type ROM such as a compact flush card, a hard disk, and any other suitable means for storing a program therein.

A storage medium storing a program causing each of the second servers 120 to execute the steps as shown in FIG. 3 may be accomplished by programming functions of the steps with a programming language readable by a computer, and recording the program in a storage medium such as the above-mentioned ones.

A hard disc equipped in a server may be employed as a storage medium. It is also possible to accomplish the storage medium in accordance with the present invention by storing the above-mentioned computer program in such a storage medium as mentioned above, and reading the computer program by other computers through a network.

The second memory 423 stores therein various data and parameters, and presents a working area to the central processing unit 421. That is, the second memory 423 stores data temporarily necessary for the central processing unit 421 to execute the program.

The central processing unit 421 reads the program out of the first memory 422, and executes the program. Thus, the central processing unit 421 operates in accordance with the program stored in the first memory 422. In the present embodiment, the first memory 422 stores therein a program for executing the process shown in FIG. 3, that is, the process for causing each of the second servers 120 to return a reduced amount of the cryptocurrency 170 to the first server 110. The central processing unit 421 executes the steps shown in FIG. 3 in accordance with the program.

The IO unit 440 includes a manipulation device 441, a display 442, and a speaker 443.

The manipulation unit 441 is comprised of a ten-key pad, for instance. Various data is input into the cellular phone 400 through the manipulation unit 441.

The display 442 is comprised of a liquid crystal display (LCD), for instance. The display 442 displays computation results carried out by the control unit 140, and various data.

Audio data received from other cellular phones is output through the speaker 443.

The memory 430 works as an external memory for the control unit 140. Computation results carried out by the control unit 140 and various data are stored in the memory 430.

The clock 150 measures passage of time, and transmits a signal indicative of the measured passage of time to the control unit 140. In particular, each time a predetermined period of time has passed, the clock 150 transmits a signal indicating that the predetermined period of time has passed, to the control unit 140.

The wallet 160 is comprised of an application for storing therein later-mentioned cryptocurrency 170 having been received from the first server 110.

The control unit 150 included in the first server 110 is designed to have the same structure and functions as those of the control unit 140 included in the second server 120.

Data to be transmitted to the second servers 120 from the first server 110 is designed to have such a structure that an amount thereof is reduced with passage of time. For instance, a half-life may be chosen as an algorism in accordance with which an amount of data is reduced. In physics, a half-life indicates a period of time in which a half amount of radioactive isotope (RI) is turned into another nuclide due to radioactive decay. The data received by each of the second servers 120 is reduced in an amount (amount) to a half each time a half-life has passed.

For instance, the data may be designed to comprise a particular cryptocurrency. Hereinbelow is assumed that the data is constructed as cryptocurrency 170.

The cryptocurrency 170 is transmitted to each of the second servers 120 from the first server 110, and is stored in the wallet 160 of each of the second servers 120.

As mentioned above, the cryptocurrency 170 is reduced in an amount with passage of time. In the case that a half-life is chosen as an algorithm for the reduction in an amount of the cryptocurrency 170, assuming that a half-life is one year (365 days), a rate of today relative to tomorrow in of an amount of the cryptocurrency 170 is 365-th root of 2 (2^{1/365}):1. In other words, an amount of the cryptocurrency 170 is reduced at a rate of (2^{1/365}−1) day by day. For instance, the cryptocurrency 170 of 10,000 yen (JPY) is reduced next day to 9,981 yen, reduced a week later to 9,439 yen, reduced half a year later to 7,492 yen, reduced a year later to 5,000 yen, and reduced two years later to 2,500 yen.

The reduction in an amount of the cryptocurrency 170 in accordance with a half-life starts at the next day following a day of the issuance of the cryptocurrency 170. The issued cryptocurrencies 170 are all reduced in an amount day by day in accordance with a half-life. Accordingly, the cryptocurrencies 170 having been received by the second servers 120 start being reduced the next day following a day of the receipt of the cryptocurrencies 170.

The system 100 having the structure as mentioned above operates as follows.

FIG. 3 is a flow-chart showing the steps to be carried out by the system 100.

The first server 110 periodically transmits the cryptocurrencies 170 to each of the second servers 10. For instance, the first server 110 transmits the cryptocurrencies 170 to each of the second servers 10 every day, once a week or once a month (Step S100 in FIG. 3).

The cryptocurrencies 170 having been received in each of the second servers 120 are stored in each of the wallets 160 (Step S110 in FIG. 3).

As mentioned earlier, the cryptocurrencies 170 having been stored in the wallet 160 of each of the second servers 120 start being reduced in an amount at a day following the day of the issuance or storage of the cryptocurrencies 170, and are reduced day by day in accordance with a half-life.

After the first server 110 transmitted the cryptocurrency to each of the second servers 120, the clock 150 in each of the second servers 120 starts measuring passage of time starting at a point of time when each of the second servers 120 has received the cryptocurrency 170 (Step S120 in FIG. 3).

The clock 150 is designed to transmit a signal indicative of the measurement result to the control unit 140 every hour, for instance (Step S130 in FIG. 3).

The central processing unit 421 judges whether one day (24 hours) has passed or not in accordance with the measurement result having been transmitted from the clock 150 (Step S140 in FIG. 3).

If one day (24 hours) has not yet passed since the receipt of the cryptocurrency 170, the central processing unit 421 repeatedly judges whether one day (24 hours) has passed or not (NO in Step S140 in FIG. 3).

When one day (24 hours) has passed since the receipt of the cryptocurrency 170 by the second server 120, the central processing unit 421 calculates a reduced amount of the cryptocurrency 170 in one day (Step S150 in FIG. 3).

The cryptocurrency is reduced in an amount in accordance with a one-year (365 days) half-life. Accordingly, a reduced amount D in one day is calculated in accordance with the following formula (A).

D=R×2^{1/365}(R: amount of the cryptocurrency 170) (A)

For instance, in the case that the first server 110 transmitted the cryptocurrency 170 having a value of 10,000 yen (JPY) to each of the second servers 120, the cryptocurrency 170 is reduced by 19 yen in a first day.

Consequently, when one day (24 hours) has passed from the receipt of the cryptocurrency 170 in each of the second servers 120, the cryptocurrency 170 having a value of 9,981 yen is included in the wallet 160.

10,000−19=9,981 yen

As an alternative, the cryptocurrency 170 is reduced by 561 yen in a first week (7 days).

Consequently, when one week (7 days) has passed from the receipt of the cryptocurrency 170 in each of the second servers 120, the cryptocurrency 170 having a value of 9,439 yen is included in the wallet 160.

10,000−561=9,439 yen

Then, the control unit 140 in each of the second servers 120 transmits the reduced amount D of the cryptocurrency 170 in a first day to the first server 110 through the network 130 (Step S160 in FIG. 3).

After the control unit 140 in each of the second servers 120 transmitted the reduced amount D of the cryptocurrency 170 to the first server 110, the clock in each of the second servers 120 continues measuring passage of time starting at a point of time when each of the second servers 120 has received the cryptocurrency 170, and transmits a signal indicative of the measurement result to the control unit 140 every hour, for instance (Step S170 in FIG. 3).

The central processing unit 421 included in the control unit 140 judges whether one day (24 hours) has passed or not in accordance with the measurement result having been transmitted from the clock 150 (Step S180 in FIG. 3).

If one day (24 hours) has not yet passed since the previous transmission of the reduced amount of the cryptocurrency 170, that is, if two days (48 hours) has not yet passed since the receipt of the cryptocurrency 170 by the second server 120, the central processing unit 421 repeatedly judges whether one day (24 hours) has passed or not (NO in Step S180 in FIG. 3).

When one day (24 hours) has passed since the previous transmission of the reduced amount of the cryptocurrency 170 (YES in Step S180 in FIG. 3), the central processing unit 421 calculates a reduced amount of the cryptocurrency 170 in one day in accordance with the above-mentioned formula (A) (Step S190 in FIG. 3).

Then, the control unit 140 in each of the second servers 120 transmits the reduced amount D of the cryptocurrency 170 in a second day to the first server 110 through the network 130 (Step S200 in FIG. 3).

As mentioned above, a reduced amount of the cryptocurrency 170 is transmitted back to the first server 110 from each of the second servers 120 every passage of a day (24 hours).

Thereafter, the steps S170 to S200 shown in FIG. 3 are repeatedly carried out.

An owner of each of the second servers 120 can accomplish consumption activity such as purchase of goods by means of the cryptocurrency 170 he/she received from the first server 110. An amount of the cryptocurrency 170 stored in the wallet 160 is reduced by such consumption activity. In addition, even if an owner of each of the second servers 120 does not accomplish consumption activity, an amount of the cryptocurrency 170 stored in the wallet 160 in each of the second servers 120 is reduced with passage of days, as mentioned above.

The control unit 140 always monitors a residual amount of the cryptocurrency 170 stored in the wallet 160. When a residual amount of the cryptocurrency 170 goes below a predetermined threshold (for instance, 1,000 yen), the control unit 140 transmits a request signal to the first server 110 to request the first server 110 to additionally transmit the cryptocurrency 170. On the receipt of the request signal, the first server 110 makes the additional transmission of the cryptocurrency 170 (for instance, 10,000 yen) to the second server 120 as well as the regular transmission of the cryptocurrency 170.

Thus, a residual amount of the cryptocurrency 170 stored in the wallet 160 is close to zero, the cryptocurrency 170 is additionally supplemented to the second server 120 from the first server 110.

As an alternative, the first server 110 may be designed to periodically transmit a constant amount of the cryptocurrency 170 to each of the second servers 120. For instance, the first server 110 may be designed to transmit 30,000 yen once a week or transmit 100,000 yen once a month to each of the second servers 120.

The transmission of the cryptocurrency 170 to each of the second servers 120 from the first server 110 can be accomplished through the block chain system, similarly to conventional cryptocurrencies such as bitcoin.

The system for transmitting/receiving data, operating in such a manner as mentioned above, may be applied to a national economic policy. Hereinbelow is explained an economic policy to which the system 100 is applied.

For instance, it is supposed that the first server 110 is a server of Bank of Japan, a central bank in Japan, and each of the second servers 120 is a cellular phone 400 (see FIG. 2) owned by each Japanese citizen.

Currency available in a present society is supposed not to decrease a value thereof, that is, supposed that a value thereof is preserved. Accordingly, wealthy people can save money, and can manage their money with an interest rate. Thus, their money is only partially introduced into a market, and resultingly, a market is not much stimulated, causing economy to be inactivated. In other words, only monetary economy is activated, but real economy is not activated.

However, it is possible to stimulate and thereby promote consumption activity by applying a character of “an amount thereof being reduced with passage of time” to the cryptocurrency 170.

As a result, in a trading area in which the cryptocurrency 170 designed to reduce in an amount in accordance with a half-life is used, currency (the cryptocurrency 170) is much circulated, and economic is stimulated, making a market richer as a whole. It is expected that a present society in which a wealthy people can be more wealthy is turned into a society in which all of people involved in a market can be wealthy.

In 2020, Bank of Japan issued about 120,000,000,000,000 yen (JPY) currency by quantitative easing (QE). These currencies are circulated to financial institution such as city banks.

In the economic policy to which the system 100 is applied, the cryptocurrency 170 equal in an amount to the above-mentioned QE is distributed directly to national citizens as universal basic income (UBI). For instance, Bank of Japan (central bank in Japan) directly transmits a constant amount of currency (for instance, 200,000 yen) once a month to the wallet 160 of each of national citizens. This makes per a month credit creation calculated by the following formula.

200,000×number of national citizens

In view of national citizens, a policy of direct distribution of currency in place of purchase of national bonds from city banks will be highly supported. In the case that a reduction rate due to a half-life is greater than an interest rate, the cryptocurrency 170 will not be saved, and thus, consumption will be promoted and economic is stimulated, resulting in that a market, specifically real economy can be activated.

England Bank (central bank of United Kingdom) releases that consumption activity by national citizens can be stimulated by carrying out buying operations directly to national citizens through legal currency (currency a value and an amount of which are not reduced), and thus, GDP increases by 3%. Thus, an advantage of encouragement of economic activity can be expected.

As mentioned above, consumption activity of national citizens is promoted by carrying out buying operations even through currency whose value and amount are not reduced. Since consumption activity is promoted also by the cryptocurrency 170 (currency whose amount is reduced with passage of time) in addition to the promotion of consumption activity by legal currency, GDP is expected to further increase.

The cryptocurrency 170 having a value of 200,000 yen distributed every month to national citizens by the universal basic income (UBI) policy is reduced day by day in accordance with a half-life. In the system 100, a reduced amount of the cryptocurrency 170 is automatically transmitted back to the central bank (the first server 110) from all of the wallets 160. Thus, when a year as a half-life has passed, a half of the total amount of credit creation (200,000×number of national citizens per a month) is returned to the central bank.

TABLE 1
unit: 1,000,000,000,000 yen

| | 1st | 2nd | 3rd | 4th | 5th | 6th | 7th |
|---|---|---|---|---|---|---|---|
| | Year | Year | Year | Year | Year | Year | Year |
| UBI issuance | 240 | 240 | 240 | 240 | 240 | 240 | 240 |
| Collection | 0 | 120 | 180 | 210 | 225 | 233 | 237 |
| General Account | 0 | 120 | 120 | 120 | 120 | 120 | 120 |
| Surplus | 0 | 0 | 60 | 90 | 105 | 113 | 117 |

Table 1 shows a correlation among UBI issuance, collection, general account and surplus.

For instance, supposing that 2,000,000 yen is distributed to national citizens per a year, a total of 240,000,000,000,000 yen is annually created in the wallets 160 owned by 120,000,000 national citizens, and, as shown in Table 1, the central bank (the first server 110) receives 120,000,000,000,000 yen (180,000,000,000,000 yen or more two or more years later) a year later in the form of the cryptocurrency 170 from the wallets 160. By converting the returned cryptocurrency 170 into yen (JPY) as legal currency to thereby introduce into national treasury, it is possible to cover the annual general account (120,000,000,000,000 yen), resulting in creation of a tax-free country.

A reduced amount of the cryptocurrency 170 in accordance with a half-life can be substantially a tax. The current consumption tax system is dependent on consumption activity of consumers, and can be understood as penalty against consumption, including contradiction for national citizens to reduce consumption.

On the other hand, a tax (a reduced amount of the cryptocurrency 170) is automatically collected in the system 100 in which an amount of the cryptocurrency 170 is reduced in accordance with a half-life, and accordingly, fiscal resources can be made stable. Since reduction in an amount of the cryptocurrency 170 in accordance with a half-life can be understood as penalty against no consumption, it is possible to expect promotion of consumption by national citizens.

It is possible to stop reduction in an amount of the cryptocurrency 170 collected to the central bank (the first server 110) from national citizens (the second servers 120). That is, it is possible to design not to reduce a collected amount of the cryptocurrency 170. By so designing the cryptocurrency 170, the central bank or the nation is able to spend the collected cryptocurrency 170 without reduction thereof. For instance, it is possible to cover a general account with the collected cryptocurrency 170, and if surplus is generated, the surplus may be delivered to foreign countries, in which case, inflation is not caused in Japan. It is possible to accomplish foreign aid such as ODA (Official Development Assistance) or purchase US treasury notes, EU bonds or Chinese government bonds.

In a society in which conventional currency (legal currency) a value and an amount of which are not reduced with passage of time is available, wealthy people can manage their money with an interest of rate to thereby acquire more money. Their money is not circulated in a market, and accordingly, a market is not stimulated. Laborers in a society in which economy is not good cannot afford to save money. Thus, a difference between the poverty and the wealth tends to be increased.

In contrast, in a society in which the cryptocurrency 170 an amount of which is designed to be reduced in accordance with a half-life is introduced, consumption activity is promoted and economy is stimulated, resulting in that a benefit is provided to those involved in a market. In other words, a switch to the cryptocurrency 170 from current legal currency may be a big turning point at which a society having low abstraction of “a priority is given to individual benefit” is turned into a society having high abstraction of “a priority is given to all”.

Universal basic income (UBI) in which the cryptocurrency 170 an amount of which is reduced in accordance with a half-life is used is characterized in that the cryptocurrency 170 can be directly transmitted into each of the wallets 160, and that UBI has a purpose of promoting consumption activity. To this end, it is possible to prohibit to exchange the cryptocurrency 170 to legal currencies such as Japanese yen (JPY) and US dollar (USD), and to purchase financial products such as securities and precious metals for saving money. It is basically supposed that the cryptocurrency 170 is used for purchasing consumables, foods daily necessities and cloths, paying public utility charges of lifeline and house rent, or compensating for travel fees.

It is possible to prohibit to exchange the cryptocurrency 170 to legal currencies and purchase financial products by introducing a prohibition rule into a program defining the cryptocurrency 170. Purchase of products by using the cryptocurrency 170 is accomplished through the network 130. When the program determines that products to be purchased are financial products for saving money, the program does not allow to continue the purchase process, and terminates the purchase.

Silvio Gesell (1862-1930), a German economist and businessman, questioned a present society in which an interest rate is justified because only currency is not reduced in a value although everything is reduced in a value, and thus, the wealthy can live by virtue of an interest rate without working so hard. In order to solve this problem, he suggested the concept of free money in his book “The Natural Economic Order”.

The free money is allowed to use on condition that a predetermined amount of a stamp should be periodically (for instance, per a week or per a month) attached to a bill. The free money has a purpose of preventing currency from being into dead storage, promoting circulation of currency, and decreasing an interest of rate. This is just reduction of currency in a value, and is essentially different from reduction of currency in an amount in the cryptocurrency 170.

As mentioned above, the system 100 in accordance with the first embodiment can be a base of a policy useful to a society, and is potential for solving current economic problems.

It should be noted that the system 100 in accordance with the first embodiment is not to be limited to the above-mentioned structure, but has many various options.

Though the system 100 is designed to include a single first server 110, the system 100 may be designed to include two or more first servers 110.

For instance, in the case that the system 100 is designed to include two first servers 110, one of the first servers 110 may be designed to deal with the cryptocurrency 170 an amount of which is reduced in accordance with a half-life, and the other may be designed to deal with cryptocurrencies mentioned in later-mentioned second and third embodiments.

The second servers 120 in the system 100 are designed to comprise a cellular phone 400. As an alternative, the second servers 120 may be designed to comprise a personal computer, a tablet or a mobile device designed only for receiving a cryptocurrency.

The clock 150 is included in each of the second servers 120 in the system 100. As an alternative, the clock 150 may be designed to be set outside of each of the second servers 120 as a device independent from each of the second servers 120, in which case, the clock 150 transmits a radio-signal indicative of measured time to the controller 140.

The cryptocurrency 170 is designed to be reduced in an amount to a half per a year (365 days). It should be noted that an administrator (currency issuer) of the first server 110 may choose any algorithm for determining a rate at which an amount of the cryptocurrency 170 is reduced.

The clock 150 in the system 100 is designed to hourly transmit a signal indicative of the measured time to the controller 140. As an alternative, the clock 150 may be designed to transmit a signal indicative of the passage of one day (24 hours) to the controller 140 when one day (24 hours) has passed.

An administrator (Bank of Japan or the issuer of the cryptocurrency 170) may design that the cryptocurrency 170 having been returned to the first server 110 from the second servers 120 is not reduced in an amount.

The cryptocurrency 170 in the system 100 is designed to be reduced in an amount with the passage of time. The cryptocurrency 170 may be designed to be reduced in both an amount and a value with the passage of time. For instance, the cryptocurrency 170 may be designed to be reduced in an amount to a half, and further, in a value to a half when a half-life has passed.

In the above-mentioned case, it is not necessary to set a speed at which the cryptocurrency 170 is reduced in an amount equal to a speed at which the cryptocurrency 170 is reduced in a value. Those speeds may be different from each other. For instance, a half-life may be chosen as a speed at which the cryptocurrency 170 is reduced in an amount, and other factor (for instance, a price increase rate, a percentage change of GDP, a percentage change of annual average income) may be chosen as a speed at which the cryptocurrency 170 is reduced in a value.

### Second Exemplary Embodiment

With respect to an automobile, for instance, there is a remarkable difference in a selling price between Japanese standard cars and Italian sporty cars, though there is no difference in costs of raw materials (physical value). Accordingly, it is considered that a factor by which a big difference in a selling price is caused comprises informational value such as power of brand and/or design. In view of this sample case, it is considered that a price consists of a sum of physical value and informational value.

Prices of most of daily necessities surely include informational value. Consequently, if physical value and informational value can be separated from each other, prices of most of daily necessities can be significantly reduced. That is, it is possible to set the prices close to physical value.

Informational value includes socially useful services provided by corporate activities as well as brand and/or design.

For instance, railway companies in Japan provide a value of service that trains are managed to run just in accordance with a time table. Home delivery companies provide a value of service that goods are safely delivered to a designated place at a designated time.

It is possible to issue a cryptocurrency where the informational value of services caused by such company activities acts as a security. In other words, it is possible to issue a cryptocurrency based on the informational value including a service by the name of “information cryptocurrency”, for instance.

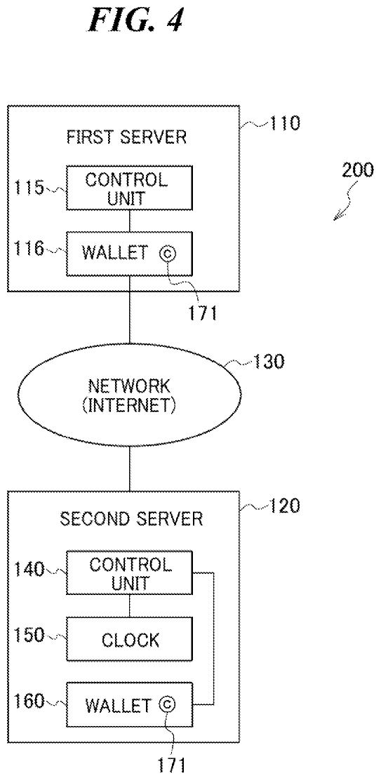

FIG. 4 is a block diagram illustrating a system 200 for transmitting/receiving data, in accordance with the second exemplary embodiment of the present invention.

In the system 200, a cryptocurrency 171 is used in place of the cryptocurrency 170 used in the first exemplary embodiment. The cryptocurrency 171 is characterized in that an amount thereof is reduced to a half when a half-life has passed, similarly to the cryptocurrency 170, and that the cryptocurrency 171 is based on such informational value as mentioned above.

The second server 120 in the system 200 is administrated by a railway company, for instance. The railway company provides a society a value of service that trains run in accordance with a time table. Activity of managing trains to run in accordance with a time table has immaterial value. Thus, a central bank (a nation or a financial institution corresponding to a central bank) administrating the first server 110 newly issues a cryptocurrency 171 by the name of “railway cryptocurrency”, for instance, and loans the cryptocurrency 171 to the railway company, that is, newly makes creation of credit to the railway company.

In a standpoint of the railway company, the railway company can acquire funds not necessary to return, similarly to funds acquired by issue of stocks, and further, strengthen railway activities by virtue of the thus acquired funds.

Hereinbelow is explained an example of the above-mentioned information cryptocurrency.

The inventor of this application has started the operation of “coaching coin” which is one of information cryptocurrencies and deals with coaching knowledge, at the end of 2021, as demonstration experiment of information cryptocurrency. About 200 persons have acquired the coaching coin at October in 2022. The coaching coins have been issued to about 20,000 coaching knowledge by now. The coaching coins are issued by the coaching coin bank (the coaching coin bureau) corresponding to a central bank.

Coaching activities to which the coaching coin is to be issued and an amount of issuance of the coaching coin may be determined by the bureau or weighted direct election by users.

For instance, the coaching coin is issued to attending to coaching seminar, joining sessions, and purchasing books, moving pictures or DVD.

An amount of issuance of the coaching coin is about 3% of the coins owned by a coach in the case of attending to a session, 3 coins per a book, and 6 coins per attending to a seminar, for instance.

### Third Exemplary Embodiment

In the system 100 in accordance with the first exemplary embodiment, the cryptocurrency 170 is unconditionally transmitted to the second servers 120 from the first server 110. The first server 110 may be designed to conditionally transmit the cryptocurrency 170 to the second servers 120. That is, the first server 110 may be designed to transmit the cryptocurrency 170 to the second servers 120 only when an owner of each of the second servers 120 meets a predetermined condition or requirement.

In the system 300 in accordance with the third exemplary embodiment, as shown in the later-mentioned examples, the first server 110 transmits the cryptocurrency to the second servers 120 only when an owner of each of the second servers 120 meets a predetermined condition or requirement.

The cryptocurrency 170 having been mentioned in the second exemplary embodiment can be considered to be provided only when an owner of each of the second servers 120 meets a predetermined condition or requirement, that is, a condition that a railway company, an owner of the second server 120, operates a railroad in accordance with a timetable.

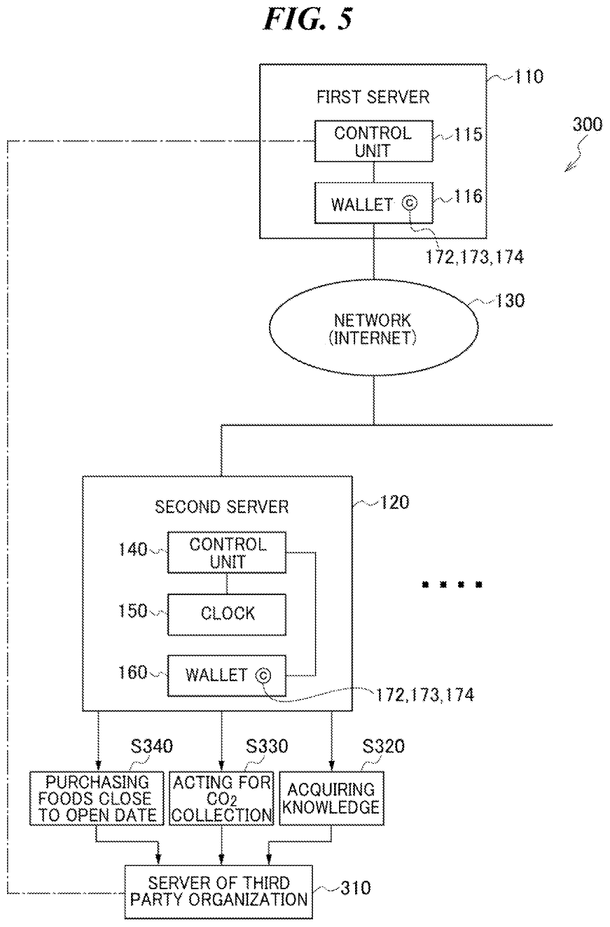

FIG. 5 is a block diagram of a system 300 for transmitting/receiving data, in accordance with the third exemplary embodiment.

As illustrated in FIG. 5, the system 300 is designed to additionally include a server 310 of a third party in comparison with the system 100.

When an owner of the second server 120 meets a condition or requirement predetermined by a third party of an administrator of the first server 110, the server 310 transmits a signal indicative of the accomplishment of a predetermined condition or requirement to the first server 110. On receipt of the signal, the control unit 115 of the first server 110 transmits later-mentioned cryptocurrency 172, 173 or 174 to the second server 120. The cryptocurrencies 172, 173 and 174 are identical with the cryptocurrency 170, but are distinguished from the cryptocurrency 170, because the cryptocurrencies 172, 173 and 174 are issued with a condition different from the condition with which the cryptocurrency 170 is issued.

The first server 110 in the third exemplary embodiment may be administrated by a country (a national bank) or a financial institution such as a bank managed by a third party. The first server 110 not only in the current exemplary embodiment, but also other exemplary embodiments may be administrated by an individual or a juridical person as well as a nation. For instance, a juridical person doing a business (for instance, the organization issuing the above-mentioned coaching coins) can issue various cryptocurrencies as an administrator of the first server 110 with respect to his/her business.

Hereinbelow are explained examples of a condition or requirement to be accomplished by an owner of the second server 120.

### First Example

In a current society, everyone needs to pay much school expenses in order to receive higher education. Accordingly, there is caused a social problem that a lot of persons cannot pay school expenses and thus cannot have an opportunity of the learning. This problem can be solved by a cryptocurrency.

The first example of a condition or requirement which an owner of the second server 120 needs to meet is that an owner of the second server 120 acquires certain knowledge.

When an owner of the second server 120 acquires knowledge from a third party (step S320 in FIG. 5), for instance, when an owner of the second server 120 attends to a lesson (including a lesson of music or art and exercise of sport) in a third party organization or when purchases teaching materials such as a book from a third party organization, the server 310 of the third party organization so notifies the first server 110. Then, the first server 110 pays a cryptocurrency 172 (by the name of “knowledge coin”, for instance) to the second server 120 in accordance with a time of the lesson, a difficulty of the lesson, a price of the book, or a number of pages of the book. An amount of the cryptocurrency 172 to be paid may be determined by an administrator of the first server 110.

An owner of the second server 120 can acquire new knowledge through the use of the thus acquired cryptocurrency 172. For instance, he/she can attend to other lessons or newly purchase teaching materials in a block of the cryptocurrency 172, and thus, can newly acquire the cryptocurrency 172. That is, more and more he/she acquires knowledge, he/she can acquire a higher amount of the cryptocurrency 172.

As mentioned above, the first example accomplishes a system in which a person who wants to study can study so much.

For instance, children in Japan acquire much knowledge in both an elementary school and a junior high school in compulsory education system, and hence, Japan government (the first server 110) may transmit the cryptocurrency 172 to children for acquisition of the knowledge. Children having acquired the cryptocurrency 712 can enter a high school and a university, resulting in that a society in which persons who want to study can study so much can be realized.

### Second Example

It is currently required to reduce carbon dioxide (CO₂) emission because CO₂ causes an athermal of the earth. This problem can be solved through the use of cryptocurrency.

For instance, when an owner of the second server 120 purchases an apparatus from a third party organization for collecting CO₂ or voluntarily acts for collection of CO₂ in a third party organization (step S330 in FIG. 5), the server 310 so notifies the first server 110, and then, the first server 110 pays cryptocurrency 173 (by the name of “CO₂ coin”, for instance) to the second server 120 in accordance with a number of the purchased CO₂ collection apparatuses or a time of the voluntary action.

An object of the second example is to realize a society in which the cryptocurrency 173 has to be paid as well as purchase price (legal currency) in order to buy products which emit much CO₂ when fabricated.

In such a society, for instance, when you buy a cup of coffee in a convenience store, you have to pay not only 100 yen (JPY: legal currency) as a price of a cup of coffee, but also the cryptocurrency 173 corresponding to CO₂ emission having been caused by transportation of coffee beans, fabrication of a coffee cup, boiling water and so on.

Some countries are currently carrying out a policy for reducing CO₂ such as dealing of a right to emit CO₂ or carbon tax. However, such a policy can be rephrased “you are allowed to emit CO₂, if you pay money (tax) accordingly”. That is, it can be said that the policy admits emission of CO₂, and thus, the policy cannot be considered to be direct action for reducing CO₂.

Since the cryptocurrency 173 is given only to actions to be carried out to realize a sustainable society aiming at reduction of CO₂, purchasing the cryptocurrency 173 can be direct action leading to reduction of CO₂.

### Third Example

One of worldwide problems is shortage of foods. The cryptocurrency is effective to the problem.

For instance, when an owner of the second server 120 purchases foods close to an open date (or expiration date) from a third party organization (food shop) (step S340 in FIG. 5), the server 310 of the third party organization notifies the first server 110 of the purchase by the owner, and then, the first server 110 pays the cryptocurrency 174 (by the name of “food loss coin”, for instance) to the second server 120 in accordance with days to the open date. A greater amount of the cryptocurrency 174 is paid to the second server 120 with the shorter days to the open date.

This third example provides one of aids to solve a food loss problem, that is, a problem that a food an open date of which expires is disposed.

An owner of the second server 120 can newly purchase foods through the use of the thus acquired cryptocurrency 174. Thus, there is realized a system in which a person who acts for contribution to reduction of food loss can newly acquire foods. Herein, it is not necessary to use conventional legal currency.

As mentioned earlier, as a general rule, it is prohibited to exchange the cryptocurrency 170 to other cryptocurrencies. However, as an exception, it is possible to design the cryptocurrencies 170 to 174 in the first to third exemplary embodiments to be exchangeable to one another.

For instance, the cryptocurrency 172 obtained by acquiring knowledge is designed to be exchangeable to the food loss coin 174, in which case, any person can obtain the cryptocurrency 172 by studying any subjects, exchange the thus obtained cryptocurrency 172 to the food loss coin 174, and acquire foods through the use of the food loss coin 174.

One of current social problems is that poor children in developing countries are driven to work, and accordingly, cannot go to school to thereby fail to receive education. This enlarges education inequality. In accordance with the third example, study is directly linked to foods, providing one of aids to solve educational inequality.

### Fourth Exemplary Embodiment

Physically spatial value can be grasped as inherent information, and this inherent information can be valued through a cryptocurrency.

For instance, a country having rare metals under the ground can be said to have informational value of “resources exist under the ground”, even if those resources are not yet excavated. The country can turn the informational vale to non-fungible token (NFT) to thereby issue a cryptocurrency 175 (by the name of “NFT coin”, for instance). That is, the cryptocurrency 175 is based on non-excavated resources as a security. For instance, NFT can be issued for every weight unit (pound or kilogram) of non-excavated resources.

Since it is not necessary for the country to directly excavate resources, it is possible to avoid the resources from actually giving them to existing economic giants.

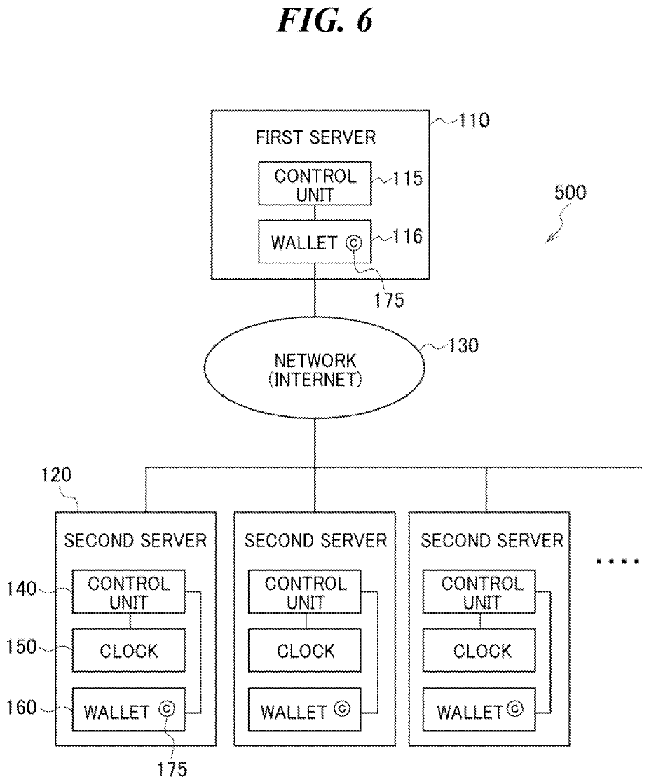

FIG. 6 is a block diagram of a system 500 for transmitting/receiving data in accordance with the fourth exemplary embodiment.

As illustrated in FIG. 6, the system 500 has the same structure as the structure of the system 100 in accordance with the first exemplary embodiment.

The first server 110 is administrated by a government of a nation having rare metal resources, and the sever servers 120 are owned by persons who purchased the NFT coin 175.

For instance, the administrator of the first server 110, that is, a government of a nation having rare metal resources may mine rare metal resources only when a market price of the NFT coin 175 goes below a predetermined price. Thus, it is possible to continuously and stable run economy. If money exchange rate can be kept stable, it would not be necessary to mine underground resources.

The exemplary advantages obtained by the above-mentioned exemplary embodiments are described hereinbelow.

The system for transmitting/receiving data in accordance with the above-mentioned exemplary embodiments can be applied to a national economic policy, and further, can provide economic serviceability to a society.

For instance, it is supposed that the first server is administrated by Bank of Japan, that is, a central bank in Japan, the second servers are owned by Japanese people, and data transmitted to the second servers from the first server constitutes cryptocurrency. A predetermined amount of the cryptocurrency is transmitted to all Japanese people every month (or every week) from Bank of Japan. Japanese people can cover their living expenses with this cryptocurrency, and further, can make various consumption activities, activating real economy in Japan. The cryptocurrency transmitted from the first server is designed to reduce in an amount day by day. A reduced amount of the cryptocurrency is returned to the first server. Japan government can cover general account with the cryptocurrency having returned back to the first server, resulting in that a no-tax nation can be formally realized.

While the present invention has been described in connection with certain exemplary embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

The entire disclosure of Japanese Patent Application No. 2022-176461 filed on Nov. 2, 2022 including specification, claims, drawings and summary is incorporated herein by reference in its entirety.

What is claimed is:

1. A system for transmitting and receiving data, including:
a first server for transmitting data;
at least one second server for receiving the data from the first server;
a network for connecting the first server and the second server to each other; and
a clock for measuring passage of time,
the data having such a structure that at least amount among value and amount thereof is reduced with passage of time,
the clock transmitting a time-passage signal to the second server every time a predetermined period of time has passed from a point of time at which the data was transmitted to the second server from the first server through the network, the time-passage signal indicating that the predetermined period of time has passed,
the second server, on receipt of the time-passage signal, transmitting a reduced amount of the data to the first server.

2. The system as set forth in claim 1, wherein the transmission of the data to the second server from the first server is carried out only when the second server satisfies a predetermined requirement.

3. The system as set forth in claim 2, wherein the predetermined requirement is that an owner of the second server provides formless informational value to a society.

4. The system as set forth in claim 2, wherein the predetermined requirement is that an owner of the second server acquires knowledge from others.

5. The system as set forth in claim 4, wherein the first server transmits the data to the second server in an amount in accordance with an amount of knowledge the owner of the second server acquired.

6. The system as set forth in claim 1, wherein the data comprises cryptocurrency.

7. The system as set forth in claim 1, wherein the passage of time with which the at least amount of the data is reduced is a half-life, an amount of the data being reduced to a half when the half-life has passed.

8. The system as set forth in claim 1, wherein the second server comprises a cellular phone.

9. The system as set forth in claim 1, wherein the clock is included in the second server.

10. The system as set forth in claim 6, wherein the first server is a server of a central bank in a certain nation, and the second server is a server of people of the certain nation.

11. The system as set forth in claim 6, wherein the cryptocurrency is prohibited to exchange with other cryptocurrencies and legal currencies.

12. A method of transmitting and receiving data between first and second servers through a network,
the data having such a structure that at least amount among value and amount thereof is reduced with passage of time,
the method including:
transmitting data to the second server from the first server through the network;
successively measuring every passage of a predetermined period of time starting from a point of time at which the data was transmitted to the second server from the first server through the network; and
the second server transmitting a reduced amount of the data to the first server every time the predetermined period of time has passed.

13. The method as set forth in claim 12, wherein the transmitting data to the second server from the first server is carried out only when the second server satisfies a predetermined requirement.

14. The method as set forth in claim 13, wherein the predetermined requirement is that an owner of the second server provides formless informational value to a society.

15. The method as set forth in claim 13, wherein the predetermined requirement is that an owner of the second server acquires knowledge from others.

16. The method as set forth in claim 15, wherein the first server transmits the data to the second server in an amount in accordance with an amount of knowledge the owner of the second server acquired.

17. The method as set forth in claim 12, wherein the data comprises cryptocurrency.

18. The method as set forth in claim 12, wherein the passage of time with which the at least amount of the data is reduced is a half-life, an amount of the data being reduced to a half when the half-life has passed.

19. The method as set forth in claim 12, wherein the second server comprises a cellular phone.

20. The method as set forth in claim 12, wherein the successively measuring every passage of a predetermined period of time is carried out in the second server.

21. The method as set forth in claim 16, wherein the first server is a server of a central bank in a certain nation, and the second server is a server of people of the certain nation.

22. The method as set forth in claim 17, wherein the cryptocurrency is prohibited to exchange with other cryptocurrencies and legal currencies.

23. A server for receiving data from other servers through a network,
the data having such a structure that at least amount among value and amount thereof is reduced with passage of time,
the server including a clock for measuring passage of time to detect whether a predetermined period of time has passed from a point of time at which the server received the data from the other server,
the server transmitting a reduced amount of the data to the other server when the passage of the predetermined period time was detected by the clock.

24. The server as set forth in claim 23, wherein the data comprises cryptocurrency.

25. The server as set forth in claim 23, wherein the passage of time with which the at least amount of the data is reduced is a half-life, an amount of the data being reduced to a half when the half-life has passed.

26. The server as set forth in claim 23, wherein the server comprises a cellular phone.

27. The server as set forth in claim 26, wherein the other server is a server of a central bank in a certain nation, and the server is a server of people of the certain nation.

28. A non-transitory storage medium readable by a computer and storing a program therein for transmitting data having been received from a first server through a network, back to the first server,
the data having such a structure that at least amount among value and amount thereof is reduced with passage of time,
the storage medium being included in a second server having a clock,
wherein the program causes the second server to carry out:
making the clock to work to successively measure every passage of a predetermined period of time starting from a point of time at which the data was received at the second server from the first server; and
transmitting a reduced amount of the data to the first server every time the passage of the predetermined period of time was detected by the clock.

29. The non-transitory storage medium as set forth in claim 28, wherein the data comprises cryptocurrency.

30. The non-transitory storage medium as set forth in claim 28, wherein the passage of time with which the at least amount of the data is reduced is a half-life, an amount of the data being reduced to a half when the half-life has passed.

31. The non-transitory storage medium as set forth in claim 28, wherein the second server comprises a cellular phone.

32. The non-transitory storage medium as set forth in claim 29, wherein the program prohibits the cryptocurrency to exchange with other cryptocurrencies and legal currencies.
